(19) United States
(12) Patent Application Publication
(10) Pub. No.: US 2006/0265428 A1
(43) Pub. Date: Nov. 23, 2006

(54) Method and apparatus for processing user's files

(75) Inventors: Haixin Chai, Beijing (CN); Rong Yao Fu, Beijing (CN); Sheng Lu, Beijing (CN); Xiaoping Zhang, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/412,531

(22) Filed: Apr. 27, 2006

(30) Foreign Application Priority Data
Apr. 28, 2005 (CN) 200510067925.9

(51) Int. Cl. G06F 17/30

(52) U.S. Cl. 707/200

(57) ABSTRACT

A method and an apparatus for processing user's files, by categorizing user's files and for generating a personal working set. Categorizing user's files is done by capturing history information about the user's operations on files; clustering the files operated by the user to generate one or more categories based on the captured history information and at least one predefined file relationship. User's history of operations on files as well as file relationships implied during user's operation can be reflected by the generated categories.

### TECHNICAL FIELD OF THE INVENTION

The present invention relates to the field of computer information processing, more particularly, relates to a method and an apparatus for processing user's files.

### BACKGROUND OF THE INVENTION

With the rapid development of network, computer users' work sites are continuously enlarged, such as office, home, or customer sites and even on the road. When computer users' work sites are switched, users need to access their personal data at a new work site to work. Generally, a surveillance tool in a computer may record a user's operations on files all the time. When the user leaves the original work site and goes to a target work site, the user often uses a mobile medium storage at the original work site to store his personal data according to the features of the target work site. After reaching the target work site, the user connects the medium storage to a computer so as to merge the personal data in the medium storage into the computer at the target work site. In this way, the user can continue using these data at the target work site. Due to the limitation of storage size of the medium storage, it is impossible to store user's all files, therefore it is necessary to filter all files of the user before storing, and only select the files possibly used in the near term to store, which constitute a personal working set (PWS) of the user. Therefore, it is needed to solve a problem about how to efficiently select the required files to generate the personal working set, and many factors would affect it while selecting the files, for example, the size of the medium storage, user purpose and so on.

Many existing methods of generating the personal working set mainly include two types, i.e. a manual generation of PWS method and an automatic generation of PWS method.

The manual generation of PWS method is that the user manually selects the required files to form the personal working set. The user manually selects the files mainly based on his subjective judgment, so such a method is lack of systematic management for all files, takes a lot of time, is easy to miss required files, and makes operation efficiency very low.

The method of automatically generating PWS by a computer generally selects files based on the accessing history of files. A surveillance engine in a computer has recorded the user's accessing history of files. When a personal working set is required to generate, appropriate files are selected from the accessing history of files according to file features, such as last accessed time, accessing frequency, size, etc., and these files constitute the personal working set. However, in such a method, each file is looked as an individual subject, only its own features are used as parameters to be selected, and file relationships are not considered, this may cause some files that actually have a high correlation are not selected into the personal working set.

### SUMMARY OF THE INVENTION

The invention is proposed in view of above technical problems, and its object is to provide a method for categorizing user's files, in which not only each file's own features but also relationships between user's files are considered to accurately categorize user's files.

Another object of the invention is to provide a method for generating a personal working set, wherein the personal working set is generated based on the categories generated by above method for categorizing user's files, so that the personal working set can predict user's demands more accurately.

Still another object of the invention is to provide an apparatus for categorizing user's files, which can categorize user's files based on file relationships.

Another object of the invention is to provide an apparatus for generating a personal working set.

According to one aspect of the invention, there is provided a method for processing user's files (specifically referred to as “a method for categorizing user's files” in the description), comprising: capturing history information about the user's operations on files; clustering the files operated by the user to generate one or more categories based on the captured history information.

According to another aspect of the invention, there is provided a method for processing user's files (specifically referred to as “a method for generating a personal working set” in the description), comprising: categorizing user's files by the method for categorizing user's files to generate one or more categories; selecting a set of files as a seed file set for a personal working set; extending the personal working set through selecting files from the one or more categories based on the seed file set.

According to still another aspect of the invention, there is provided an apparatus for processing user's files (specifically referred to as “an apparatus for categorizing user's files” in the description), comprising: a user operation capturing unit for capturing history information about the user's operations on files; a file clustering unit for clustering the files operated by the user to generate one or more categories based on the history information captured by the user operation capturing unit.

According to another aspect of the invention, there is provided an apparatus for processing user's files (specifically referred to as “an apparatus for generating a personal working set” in the description), comprising: the apparatus for categorizing user's files; a seed file set inputting unit for inputting a set of files as a seed file set for a personal working set; a PWS extending unit for extending the personal working set through selecting files from the one or more categories based on the seed file set.

### BRIEF DESCRIPTION OF THE DRAWINGS

FIG. 1 is a flow diagram of a method for categorizing user's files according to one embodiment of the invention.

FIG. 2 is a flow diagram of a method for generating a personal working set according to one embodiment of the invention.

FIG. 3 is a structural diagram of an apparatus for categorizing user's files according to one embodiment of the invention.

FIG. 4 is a structural diagram of an apparatus for categorizing user's files according to another embodiment of the invention.

FIG. 5 is a structural diagram of an apparatus for generating a personal working set according to one embodiment of the invention.

FIG. 6 is a structural diagram of an apparatus for generating a personal working set according to another embodiment of the invention.

### DETAILED DESCRIPTION OF THE PREFERRED EMBODIMENTS

It is believed that above and other objects, features and advantages of the present invention will become apparent from the following detailed description of the preferred embodiments of the present invention taken in conjunction with the drawings.

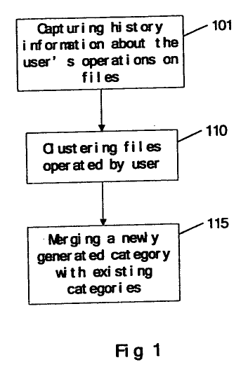

FIG. 1 is a flow diagram of a method for categorizing user's files according to one embodiment of the invention. First, in step 101, history information about the user's operations on files is captured. Generally, there is a special surveillance engine in a computer for recording information about the user's operations on files, which includes files operated on, operated time, operated types (such as opened, modified, etc.) and so on. The history information implies files' own features and file relationship features. By capturing history information about the user's operations on files, various features can be obtained as the basis of clustering files in the next step.

Particularly, the step 101 is performed according to at least one predefined file relationship to obtain information about the user's corresponding operations on files. In this embodiment, the predefined file relationship includes: file accessed time relationship, file data exchange relationship, file location relationship, file-application relationship and file source relationship.

The file accessed time relationship refers to the relationship between the accessed time of files, for example, including: simultaneously accessed relationship, in-sequence accessed relationship and in-period accessed relationship, etc. The file data exchange relationship refers to whether there is data exchange between files, for example, reference, copy and copy/paste between files. The file location relationship refers to relationship between stored locations of files, for example, whether files are saved in the same folder or disk. The file-application relationship refers to whether files have been accessed by same application. The file source relationship refers to the relationship between the sources from which files are derived, for example, whether files are downloaded from the same website or search result set, or whether files are detached from the same email.

For example, assuming that the file relationship used is the file accessed time relationship, for example, the in-period accessed relationship with files being accessed from 9 a.m. to 10 a.m. Thus in the corresponding period, the computer captures history information about the user's operations on files. Of course, there may be a plurality of predefined file relationships. In this case, history information corresponding to these file relationships respectively can be captured.

Then, in step 110, the files operated by the user are clustered to generate one or more categories based on the captured history information. Generally, related files can be clustered to generate a category based on one file relationship. For instance, in the above example, files accessed from 9 a.m. to 10 a.m. are clustered to generate a category. If there is a plurality of file relationships, a plurality of categories can be generated corresponding to each file relationship respectively.

Moreover, in the case where there is a plurality of file relationship, these file relationships can be combined to generate a category. For example, one file relationship is regarded as a primary file relationship, and other file relationship(s) is (are) regarded as secondary file relationship(s).

Preferably, the primary file relationship and the secondary file relationship can be selected in the following order: file accessed time relationship, file data exchange relationship, file location relationship, file-application relationship and file source relationship.

In this case, first, files conforming to the primary file relationship are clustered based on history information of the primary file relationship, then the clustered files are adjusted based on history information of the secondary file relationship(s), thus the resultant category is generated. For example, in the above example, if the secondary file relationship is that files are in the same folder, files accessed from 9 a.m. to 10 a.m. are adjusted according to “files are in the same folder” to generate a category. The adjustment according to the secondary file relationship includes increasing or decreasing members of the category, and adjusting relation among the members.

After the category is generated, a key file is designated in a newly generated category. The key file is a file that has the tightest relationship with other members in the category, i.e. the core of the category. For example, the key file can be designated as a file having maximum time period of being accessed or maximum accessing frequency or maximum copy/paste amount. Other files in the category are non-key files. Therefore, a category can be described with features: file set (category member), accessed time/accessing frequency, key file and history information of special file relationship(s), wherein the special file relationship can be, for example, copy/paste relationship.

It can be seen from the above description, according to this embodiment, user's operations can be captured according to the file relationship and then user's files can be clustered based on the captured history information. Therefore, the generated category can reflect not only user's history operations on files but also file relationships implied during user's operation.

Further, the newly generated category can be merged with existing categories (step 115), which is preformed according to a correlation between categories. First, a correlation between the newly generated category and each existing category is calculated. The correlation can be determined by calculating the number of the same members in both the newly generated category and the existing category. For example, it is assumed that there are 4 existing categories, the numbers of the same members between the newly generated category and the existing category are 10, 9, 6 and 3 respectively, and the corresponding correlation can be calculated as 10, 9, 6 and 3. Then, the newly generated category is merged with the existing category having the highest correlation. In the above example, the newly generated category is merged with the first existing category whose correlation is 10, so that a new category is obtained.

In addition, when the correlation between the newly generated category and the existing category is calculated, different weights can be assigned to key file and non-key file. That is, if there is a key file in the same members, the key file has a higher weight; if there is a non-key file in the same members, the non-key file has a lower weight. Therefore, the correlation between the newly generated category and the existing category is the weighted sum of the same members. For example, if a weight of a key file is set to 1.5 and a weight of a non-key file is set to 0.5, in the above example, if all the same members in both the newly generated category and the first, third and fourth existing categories are non-key files, their correlations are 0.5*10=5, 0.5*6=3 and 0.5*3=1.5, respectively. If there is one key file in the 9 same members in both the newly generated category and the second existing category, and other members are non-key files, so the correlation is 1.5*1+0.5*8=5.5. Therefore, the category having the highest correlation is the second existing category, but not the first existing category. The newly generated category is merged with the second existing category, and a new category is obtained. The importance of the key file in the category is considered in such merging, so that inner-relation between the user's operations can be better reflected by the merging of categories.

A key file of a merged category can be designated according to the above way for designating a key file, or the key files of the categories before merging can be designated as the key file in the merged category. Thus, there can be more than one key file in the merged category, for example, as the newly generated categories are merged with the existing category continuously, the number of the key files in the merged category may increase.

It can be seen from the above description, according to this embodiment, by merging the newly generated categories with the existing categories, user's operation history can be continuously reflected in the obtained categories, so that the importance of each file and the relationship between files can be reflected in a long period, therefore the real requirement of the user can be better reflected. Further, by assigning different weights to the key file and the non-key file, the difference of importance between files can be better indicated, so that inner-relation between the user's operations can be better reflected by the resultant category.

As the above procedure is performed in the computer continuously, the user's files are clustered and merged, so that the files in a category may become more and more. If the category is not maintained, the category may become useless since the category increases too much. According to one embodiment of the invention, following measures can be employed in order to maintain validity of the category.

One measure is to split a category into two or more than two categories when the number of files in the category or the category's size exceeds a predetermined threshold. Such split can be performed based on the key files of the category, that is, the category can be split according to two or more than two key files.

Another measure is to destruct a category when the number of files in the category or the category's size exceeds a predetermined threshold.

Still another measure is to record the accessed time and/or accessing frequency of each file in each category during the generation of the category. At least a part of members in a category would be deleted according to the recorded accessed time and/or accessing frequency of each file when the number of files in the category or the category's size exceeds a predetermined threshold, so that the category could meet the requirement of the category's size. Generally, the earlier the accessed time of a file is or the less the accessing frequency of a file is, the easier the deletion of file is. The lowest thresholds may be set for the accessed time and the accessing frequency respectively, and the file whose accessed time exceeds or accessing frequency is less than the corresponding threshold may be deleted.

In practice, any one of the above measures can be used for all categories, or different measures can be used for different categories.

It can be seen from the above description, according to this embodiment, the validity of the category and files in the category can be maintained, so that the category can be prevented from being useless due to the infinite increase of the number of files in the category.

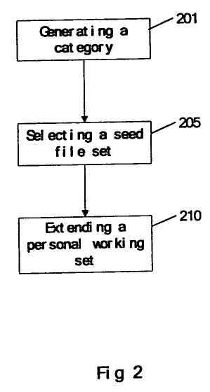

FIG. 2 is a flow diagram of a method for generating a personal working set according to one embodiment of the invention. As shown in FIG. 2, in step 201, one or more categories are generated by categorizing user's files with the above method for categorizing user's files. Detailed description has been made for the method for categorizing user's files in conjunction with the embodiment, so it will not be described herein for brevity.

Then, in step 205, a set of files is selected as a seed file set for a personal working set. The seed file set can be selected by the user, for example, any set of files is selected in all files by the user, or a certain category is selected as the seed file set based on existing categories displayed by a computer. Moreover, the seed file set can be selected by a computer, for which a current existing selecting method based on the accessing history of files can be employed. For the seed file set selected by the computer, the user can further customize it, for example, by removing some files considered to be non-correlated, or adding some files based on the seed file set, so that the seed file set can better meet the user's requirement.

After the seed file set is selected, in step 210, the personal working set is extended through selecting files from the one or more categories generated by step 201 based on the seed file set. Particularly, first, a correlation between the seed file set and each category is calculated. In this embodiment, the correlation can be calculated based on the number of the same members in both the seed file set and the category. For example, it is assumed that there are 4 existing categories, the number of the same members in both the seed file set and the 4 existing categories are 10, 6, 3 and 9 respectively, and so the corresponding correlation can be calculated as 10, 6, 3 and 9. Then, a part of or all files in one or more categories having a high correlation are selected and added to the personal working set, for example, one or more categories can be selected according to the correlation from high to low, then a part of or all files in the selected categories are selected and added to the personal working set, until the number of files in the personal working set or the size of the personal working set reaches a threshold defined by the user.

In the above example, it can be seen from the calculation that the order according to the correlation from high to low is the first category, the fourth category, the second category and the third category, so all files in the first category having the highest correlation can be added to the personal working set, then other files in the personal working set can be selected based on the threshold defined by the user.

Preferably, when the correlation between the seed file set and each category is calculated, according to one embodiment of the invention, different weights are assigned to key file and non-key file. That is, if there is a key file in the same members, the key file has a higher weight; if there is a non-key file in the same members, the non-key file has a lower weight. Therefore, the correlation between the seed file set and the category is the weighted sum of the same members.

If the weight of the key file is set to 1.5 and the weight of the non-key file is set to 0.5, in the above example, if all the same members in both the seed file set and the first, second and third categories are non-key files, their correlations are 0.5*10=5, 0.5*6=3 and 0.5*3=1.5, respectively. If there is one key file in the 9 same members in both the seed file set and the fourth existing category, and other members are non-key files, the correlation is 1.5*1+0.5*8=5.5. So, the order according to the correlation from high to low is the fourth category, the first category, the second category and the third category. Then, a part of or all files are selected and added to the personal working set based on the threshold defined by the user.

It can be seen from the above description, through the method for generating a personal working set according to the embodiment, a personal working set which meets the user's requirement can be obtained (predicted) by extending the seed file set comprising less files.

In addition, the user can input user preference information to further customize the personal working set. The user preference information includes: file type, accessed time/accessing frequency, related application and file location, or a combination thereof. In this case, after the correlation between the seed file set and each category is calculated, files are selected from the selected categories according to the inputted user preference information, and added to the personal working set.

It can be seen from the above description, the user preference information is added when the files constituting the personal working set are selected, so that the resultant personal working set may better meet the user's requirement.

Under the same inventive conception, according to another aspect of the invention, an apparatus for categorizing user's files is provided. Hereinafter, it will be described in conjunction with the drawings.

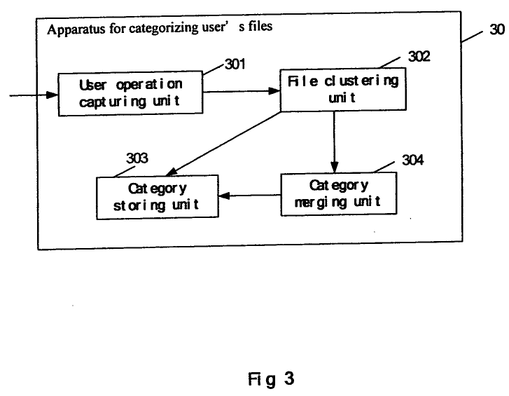

FIG. 3 is a structural diagram of an apparatus for categorizing user's files according to one embodiment of the invention;

As shown in FIG. 3, the apparatus for categorizing user's files 30 according to the embodiment includes: a user operation capturing unit 301, a file clustering unit 302, and a category merging unit 304. Wherein the user operation capturing unit 301 is used for capturing history information about the user's operations on files based on a file relationship; the file clustering unit 302 is used for clustering the files operated by the user to generate one or more categories based on the history information captured by the user operation capturing unit and storing the generated categories in the category storing unit 303; the category merging unit 304 is used for merging the new category generated by the file clustering unit 302 with an existing category.

In implementation, the user operation capturing unit 301, the file clustering unit 302 and the category merging unit 304 in the embodiment can be implemented by software operated in a universal processor or by hardware such as special circuit etc. The above category storing unit 303 can be implemented by any type of storage equipment, such as various random access memories, Flash memory, hard disk and floppy disk etc.

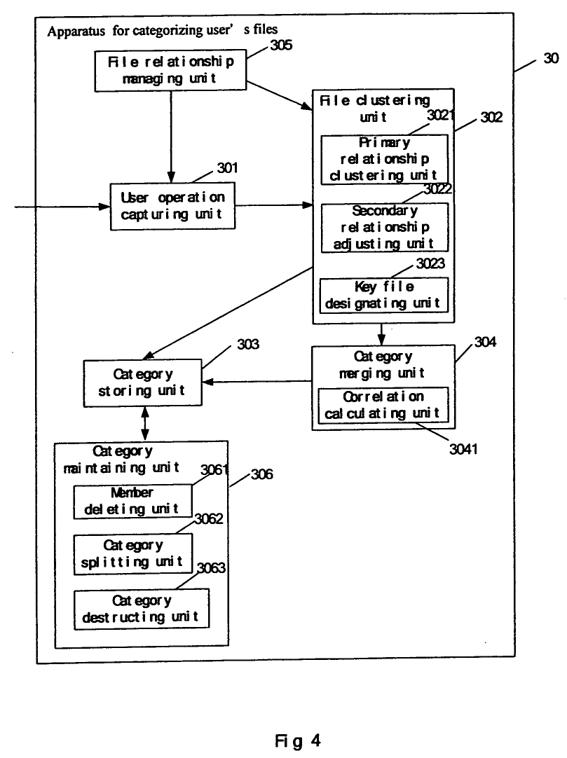

FIG. 4 is a structural diagram of an apparatus for categorizing user's files according to another embodiment of the invention. Hereinafter, the embodiment will be described in conjunction with FIG. 4, wherein the same elements with the aforesaid embodiments are labeled as the same reference numbers, and the description thereof is properly omitted.

As shown in FIG. 4, the apparatus for categorizing user's files 30 according to the embodiment includes a user operation capturing unit 301, a file clustering unit 302, a category merging unit 304, a file relationship managing unit 305 and a category maintaining unit 306. Wherein the file relationship managing unit 305 is used for managing the file relationships, wherein the user operation capturing unit 301 captures information about the user's corresponding operations on files according to the file relationship. The category maintaining unit 306 is used for maintaining the existing categories and keeping their validity.

As shown in FIG. 4, the category maintaining unit 306 further includes: a member deleting unit 3061 for deleting at least a part of members in a category; a category splitting unit 3062 for splitting a category into two or more than two categories; a category destructing unit 3063 for destructing a category. It should be noted that the category maintaining unit 306 can also include one or two units among the member deleting unit 3061, the category splitting unit 3062 and the category destructing unit 3063.

Further, the file clustering unit 302 in the embodiment further includes: a primary relationship clustering unit 3021 for clustering the files operated by the user based on the history information of the primary file relationship; a secondary relationship adjusting unit 3022 for adjusting relations among the files clustered by the primary relationship clustering unit based on the history information of one or more secondary file relationships; a key file designating unit 3023 for designating a key file in each newly generated category. The category merging unit 304 in the embodiment includes: a correlation calculating unit 3041 for calculating a correlation between the newly generated category and each existing category.

In implementation, the user operation capturing unit 301, the file clustering unit 302, the file relationship managing unit 305, the category maintaining unit 306 and the combination thereof can be implemented by software operated in a universal processor or by hardware such as special circuit etc. The above category storing unit 303 can be implemented by any type of storage equipment, such as various random access memories, Flash memory, hard disk and floppy disk etc.

In operation, the apparatus for categorizing user's files according to the embodiment described above in conjunction with FIG. 3 and FIG. 4 can implement the above method for categorizing user's files, and can capture history information about user's operation and categorize user's files as one or more categories. Here, for the specific implementation of file relationship, clustering, merging, calculation of the correlation and designation of the key file etc., since the detailed description has been made in the above embodiments, the description thereof is omitted herein.

Under the same inventive conception, according to another aspect of the invention, an apparatus for generating a personal working set is provided. Hereinafter, it will be described in conjunction with the drawings.

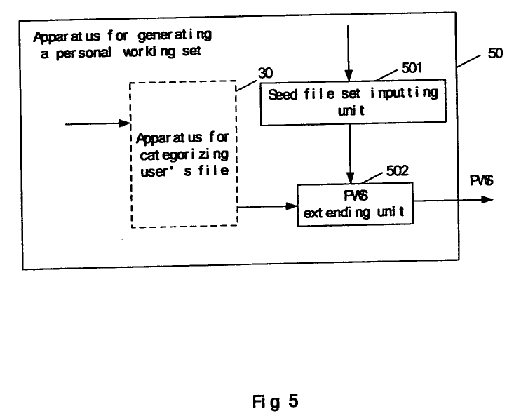

FIG. 5 is a structural diagram of an apparatus for generating a personal working set according to one embodiment of the invention.

As shown in FIG. 5, the apparatus for generating a personal working set 50 in the embodiment includes: an apparatus for categorizing user's file 30, a seed file set inputting unit 501 and a PWS extending unit 502. Wherein the apparatus for categorizing user's file 30 can be the apparatus for categorizing user's file of the invention described above in conjunction with the embodiments. The seed file set inputting unit 501 is used for inputting a set of files as a seed file set for a personal working set. The PWS extending unit is used for extending the personal working set through selecting files from one or more categories generated by the apparatus for categorizing user's file 30 based on the seed file set inputted by the seed file set inputting unit 501.

In implementation, the seed file set inputting unit 501 and the PWS extending unit 502 can be implemented by software operated in a universal processor or by hardware such as special circuit etc.

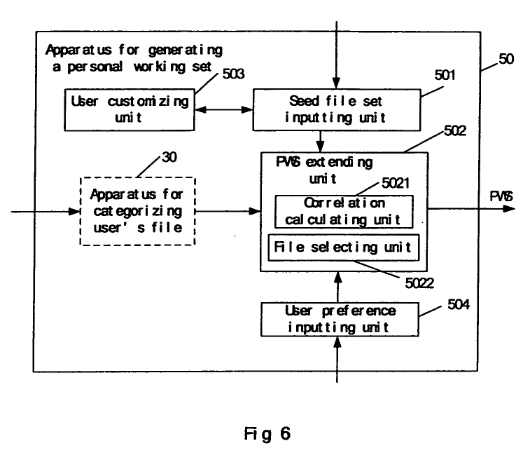

FIG. 6 is a structural diagram of an apparatus for generating a personal working set according to another embodiment of the invention. Hereinafter, the apparatus for generating a personal working set according to the embodiment will be described in conjunction with FIG. 6, wherein the same elements with the aforesaid embodiments are labeled as the same reference numbers, and the description thereof is properly omitted.

As shown in FIG. 6, the apparatus for generating a personal working set 50 in the embodiment includes: an apparatus for categorizing user's file 30, a seed file set inputting unit 501, a PWS extending unit 502, a user customizing unit 503 and a user preference inputting unit 504. Wherein the user customizing unit 503 is used for allowing the user to customize the seed file set inputted by the seed file set inputting unit 501. The user preference inputting unit 504 is used for inputting user preference information.

Moreover, the PWS extending unit 502 further includes: a correlation calculating unit 5021 for calculating the correlation between the seed file set and each category generated by the apparatus for categorizing user's file; a file selecting unit 5022 for selecting a part of or all files in one or more categories having a high correlation and adding them to the personal working set. Also, when the user inputs user preference information by the user preference inputting unit 504, the file selecting unit 5022 selects files in categories according to the user preference information.

In implementation, the seed file set inputting unit 501, the PWS extending unit 502, the user customizing unit 503, the user preference inputting unit 504 and the combination thereof can be implemented by software operated in a universal processor, or by hardware such as special circuit etc.

In operation, the apparatus for generating a personal working set according to the embodiment described above in conjunction with FIG. 5 and FIG. 6 can implement the above method for generating a personal working set, and can extend the seed file set into the resultant personal working set by using categories generated by the apparatus for categorizing user's file 30. Here, for the specific implementation of file relationship, clustering, merging, calculation of the correlation, designation of the key file and content of the user preference information etc., since the detailed description has been made in the above embodiments, the description thereof is omitted herein.

Although a method and an apparatus for categorizing user's files as well as a method and an apparatus for generating a personal working set are specifically described by some exemplary embodiments, these embodiments is not exhaustive, and those skilled in the art can achieve various changes and modifications within the scope and spirit of the invention. Accordingly, the invention is not limited to these embodiments, and the scope of the invention should be defined by the appended claims.

1. A method for processing user's files, comprising steps of
capturing history information about the user's operations on files; and
clustering the files operated by the user to generate one or more categories based on the captured history information and at least one predefined file relationship.

2. The method according to claim 1, wherein the step of capturing history information about the user's operations on files comprises:
capturing information about the user's corresponding operations on files according to said at least one predefined file relationship.

3. The method according to claim 2, wherein the file relationship includes at least one of file accessed time relationship, file data exchange relationship, file location relationship, file-application relationship and file source relationship.

4. The method according to claim 3, wherein the file accessed time relationship includes at least one of simultaneously accessed relationship, in-sequence accessed relationship and in-period accessed relationship.

5. The method according to claim 3, wherein the file data exchange relationship includes at least one of reference, copy and copy/paste.

6. The method according to claim 2, wherein the step of clustering the files operated by the user to generate one or more categories comprises:
generating a category for each file relationship.

7. The method according to claim 2, wherein the step of clustering the files operated by the user to generate one or more categories comprises:
clustering the files operated by the user based on the history information of a primary file relationship; and
adjusting relations among the clustered files based on the history information of one or more secondary file relationships.

8. The method according to claim 7, wherein the primary file relationship and the secondary file relationship are selected in the following order: file accessed time relationship, file data exchange relationship, file location relationship, file-application relationship and file source relationship.

9. The method according to claim 1, wherein the step of clustering the files operated by the user to generate one or more categories further comprises:
designating a key file in a newly generated category.

10. The method according to claim 9, wherein the key file is a file having at least one of maximum time period during which it was accessed, maximum accessing frequency, and maximum copy/paste amount in a new generated category.

11. The method according to claim 9, further comprising:
merging a newly generated category with an existing category.

12. The method according to claim 11, wherein the step of merging a newly generated category with an existing category comprises:
calculating a correlation between said newly generated category and each existing category; and
merging said newly generated category with the existing category having the highest correlation.

13. The method according to claim 12, wherein the step of calculating a correlation between said newly generated category and each existing category comprises:
calculating a number of the same members in said newly generated category and said existing category; and
calculating a correlation between said newly generated category and each existing category based on said calculated number of the same members.

14. The method according to claim 13, wherein different weights are assigned to the key file and the non-key file when calculating the correlation between said newly generated category and each existing category.

15. The method according to claim 11, further comprising:
recording access information comprising at least one of the accessed time and accessing frequency of each file in each category.

16. The method according to claim 15, further comprising:
deleting at least a part of members in a category according to said recorded access information of each file when the number of files in the category or the category's size exceeds a predetermined threshold.

17. The method according to claim 11, further comprising:
splitting a category into two or more than two categories when a predetermined threshold for said category is exceeded, wherein said predetermined threshold represents a threshold number of files in the category or a threshold size of the category.

18. The method according to claim 11, further comprising:
destructing a category when a predetermined threshold for said category is exceeded, wherein said predetermined threshold represents a threshold number of files in the category or a threshold size of the category.

19. The method according to claim 1, further comprising:
selecting a set of files as a seed file set for a personal working set; and
extending said personal working set by selecting files from said one or more categories based on the seed file set.

20. The method according to claim 19, wherein the step of extending said personal working set comprises:
calculating a correlation between the seed file set and each category; and
selecting files from at least one category having a high correlation and adding said selected files to said personal working set.

21. An apparatus for processing user's files, comprising:
a user operation capturing unit for capturing history information about the user's operations on files; and
a file clustering unit for clustering files operated by the user to generate at least one category based on the history information captured by said user operation capturing unit and at least one predefined file relationship.

22. The apparatus according to claim 21, further comprising:
a file relationship managing unit for managing said at least one predefined file relationship, wherein the user operation capturing unit captures information about user's corresponding operations on files according to the file relationship.

23. The apparatus according to claim 22, wherein the file clustering unit comprises:
a primary relationship clustering unit for clustering the files operated by the user based on the history information of the primary file relationship; and
a secondary relationship adjusting unit for adjusting relations among the files clustered by the primary relationship clustering unit based on the history information of one or more secondary file relationships.

24. The apparatus according to claim 21, wherein the file clustering unit comprises:
a key file designating unit for designating a key file in each newly generated category.

25. The apparatus according to claim 21, further comprising:
a category merging unit for merging the category newly generated by the file clustering unit with an existing category.

26. The apparatus according to claim 25, wherein the category merging unit comprises:
a correlation calculating unit for calculating a correlation between said newly generated category and each existing category.

27. The apparatus according to claim 25, further comprising:
a category maintaining unit for maintaining the existing categories and keeping their validity.

28. The apparatus according to claim 21, further comprising:
a seed file set inputting unit for inputting a set of files as a seed file set for a personal working set;
a PWS (Personal Working Set) extending unit for extending said personal working set by selecting files from said one or more categories based on the seed file set.

29. The apparatus according to claim 28, wherein the PWS extending unit comprises:
a correlation calculating unit for calculating a correlation between the seed file set and each category; and
a file selecting unit for selecting at least one file from categories having a high correlation and adding them to said personal working set.

30. A computer program having instructions which, when executed by a computer, perform the steps of claim 1.

31. A computer readable storage medium storing a computer program of the claim 30.
